(19) United States
(12) Patent Application Publication
(10) Pub. No.: US 2023/0144606 A1
(43) Pub. Date: May 11, 2023

(54) EXPEDITED APPROVAL PROCESSING OF A REQUEST FOR A PRODUCT

(71) Applicant: Better Holdco, Inc., New York, NY (US)

(72) Inventors: Jiuqing Deng, Kirkland, WA (US); Vishal Srivastav, San Carlos, CA (US); Vishal Garg, New York, NY (US); Diane Yu, New York, NY (US)

(73) Assignee: Better Holdco, Inc., New York, NY (US)

(21) Appl. No.: 17/524,188

(22) Filed: Nov. 11, 2021

(51) Int. Cl. G06Q 30/06

(52) U.S. Cl. CPC G06Q 30/0611

(57) ABSTRACT

Systems and methods are provided for processing a request for a product. The processing the request includes receiving a preliminary request from a client device for a product including identity information of a requestor and conditions of the product without specifying a particular product. The disclosed technology generates a list of eligible products for the requester to select one product. A determiner receives a request for a product and information needed to approve a use of the product (e.g., underwriting a mortgage application). The disclosed technology automatically retrieves verified information associated with the requestor from various data providers and requests for underwriting by one or more underwriters distributed over the network. The determiner determines a result of the request for the product based on decisions made the underwriters. The client device solicits for uploading additional information and documents needed to fully approve the request for the product.

### BACKGROUND

Use of mobile devices (e.g., smartphones) has enabled convenient access to and/or acquisition of a variety of resources or items, for example from remote locations. In examples, the process of acquiring an item includes simply providing a resource in exchange for the item, while the process for another item may instead include a more complex process in assessing access control for the resources (e.g., of a requestor's credibility or ability to have access to the resources). Traditionally, such steps may be complex, time-consuming, and confusing to users when data used to perform the assessment steps are distributed across computing networks at varying levels of data management credentials. The assessment steps may become further complex when the assessment steps include multiple reviewer servers across the network making respective decisions before making a final decision may be made as an aggregated result. In practice, there has been a need to enable requestors to request, acquire, or otherwise gain access to items and resources in a manner that is quick and accurate, while maintaining the benefits (e.g., to one or more providers associated with the items and resources) provided by such access control assessments and/or application processes.

The process of evaluating access to a requested resource may cover various examples. The examples of deciding an access to a requested resource may include, but are not limited to, processing by multiple servers across the network to collectively determine whether to grant access to securely stored data to a requestor with a set of credentials. Another example may include determining under a virtual server (e.g., the cloud server) in a distributed computing environment whether to allocate memory and/or processing resources to execute a set of instruction codes (e.g., an application program) as requested by users. Yet another example may include assessing by multiple reviewers (e.g., underwriters) whether to grant access to a mortgage product, thereby enabling access to resources (e.g., monetary resources) accordingly. These examples may include complex coordination and time-consuming processes to determine access to resources. Thus, developing a technology that better meets these needs while minimizing trade-offs would be desirable.

It is with respect to these and other general considerations that the aspects disclosed herein have been made. In addition, although relatively specific problems may be discussed, it should be understood that the examples should not be limited to solving the specific problems identified in the background or elsewhere in this disclosure.

### SUMMARY

According to the present disclosure, the above and other issues are resolved by providing a determiner that automatically receives verified information from data providers and coordinates with one or more reviewers over a network in determining whether to approve a request for accessing resources. This present disclosure relates to processing a request for accessing a resource. In particular, the processing the request includes obtaining and aggregating data associated with a requestor from the requestor and data servers across the network, dispatching a request to one or more reviewer servers with the obtained data to make respective decisions on whether to grant the access based on respective rules, and executing a set of review operations to make an overall determination about whether to approve the request for access to the resource. The complexity and time-consuming process may reduce or eliminate the convenience and ease-of-use that is typically associated with the use of mobile computing devices.

The disclosed technology addresses the issue of the complexity and prolonged time for the processing by automating and optimizing a real-time determination process involving multiple servers over the network for determining access to the resource, among other issues. When processing a request for a resource, a determiner may automatically retrieve background information about a requestor from data providers across a network and identify guidelines and/or rules for approving the request. The determiner may generate a personalized sequence of steps with an iterative set of questions for the requestor, for example based on information associated with the requestor and/or a requested resource. In some instances, the determiner may transmit to a reviewer server, over the network, a request for evaluating access to the resource. Data associated with the request may include an identifier of the requestor and background information associated with the requestor. In response to receiving the request, the reviewer may process the data and determine whether to approve the request for access to the item by the requestor. The determination process may include ranking the requestor according to a level of risk or a likelihood of the requestor failing to fulfill one or more conditions for accessing the item. In aspects, the one or more conditions may be ongoing, such as a request periodically providing one or more resources in exchange for access to the requested resource (e.g., monthly payment of a mortgage).

The sequence of operations performed by the determiner may thus establish access control for a resource by automatically collecting data and performing additional data collection and processing where needed. In some aspects, the terms “item” or “product” may refer to an item that itself facilitates access to a resource. For instance, such an item or product may enable the requestor to subsequently access a resource that the requestor may have otherwise been unable to acquire.

This Summary is provided to introduce a selection of concepts in a simplified form, which is further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the following description and, in part, will be apparent from the description, or may be learned by practice of the disclosure.

### BRIEF DESCRIPTIONS OF THE DRAWINGS

Non-limiting and non-exhaustive examples are described with reference to the following figures.

FIG. 1 illustrates an overview of an example system for processing a request for a resource in accordance to aspects of the present disclosure.

FIG. 2A illustrates an example of processing a request for a resource in accordance with aspects of the present disclosure.

FIG. 2B illustrates an example of a system architecture for processing a request for a resource in accordance to aspects of the present disclosure.

FIG. 3 illustrates an example of processing a request for a resource in accordance with aspects of the present disclosure.

FIG. 4 illustrates an example of a decision engine in accordance with aspects of the present disclosure.

FIG. 5A illustrates an example of a data structure for a resource specification in accordance with aspects of the present disclosure.

FIG. 5B illustrates an example of a data structure associated with determining whether to provide a resource in accordance with aspects of the present disclosure.

FIG. 5C illustrates an example of functionality used by a decision engine in determining whether to provide a resource in accordance with aspects of the present disclosure.

FIGS. 6A-C illustrate examples of a method for processing a request for a resource in accordance with aspects of the present disclosure.

FIG. 7 illustrates an example of a method for processing a request for a resource by a mobile computing device in accordance with aspects of the present disclosure.

FIGS. 8A-D illustrate examples of graphical user interface on mobile computing device in accordance with aspects of the present disclosure.

FIG. 9 is a simplified diagram of a computing device with which aspects of the present disclosure may be practiced.

### DETAILED DESCRIPTION

Various aspects of the disclosure are described more fully below with reference to the accompanying drawings, which from a part hereof, and which show specific example aspects. However, different aspects of the disclosure may be implemented in many different ways and should not be construed as limited to the aspects set forth herein; rather, these aspects are provided so that this disclosure will be thorough and complete, and will fully convey the scope of the aspects to those skilled in the art. Aspects may be practiced as methods, systems, or devices. Accordingly, aspects may take the form of a hardware implementation, an entirely software implementation or an implementation combining software and hardware aspects. The following detailed description is, therefore, not to be taken in a limiting sense.

The approval of some resources may include reviewing data associated with use of the resources in view of conditions or rules before enabling the requestor to access the resources. The process for aggregating or otherwise obtaining data associated with the requestor, the requested resources, and/or such conditions or rules may be complex, especially when there are multiple conditions or rules to be reviewed or when such data may be associated with any of a variety of data sources. In particular, the process of aggregating data and comparing against predetermined set of conditions or rules may be time-consuming when the data are stored in a distributed environment. In aspects, the data may be stored with varying levels of security at servers that are distributed across one or more networks. To further complicate the resource approval determination, a final decision for granting access to the resources may be based on an aggregate of one or more other decisions made by other review servers across the network. The respective review servers may similarly each obtain data needed for making respective decisions from multiple data servers across the network. Accordingly, a server that makes the final decision of granting the access may thus, at least in part, facilitate or orchestrate the approval determination process.

In aspects, the process facilitated by the final decision-making server may include multiple steps. For example, the final decision-making server may first obtain information associated with the requestor and may thus obtain associated data for the evaluation process. Second, the final decision-making server may identify data used for distributed reviewer servers to make respective decisions on granting the access to the requested resources. Additionally, data may be obtained from data or document servers may similarly be used as part of the evaluation. In some instances, a request may be transmitted to a reviewer server with the data with which it may make its respective access determination. Accordingly, the respective access determinations may be received from such servers over the network. As a result, the final decision-making server may generate a final determination for granting the requestor access to the requested resources based on the aggregated results from the reviewer servers and/or obtained data associated with the requestor, among other examples.

Thus, while more quickly and efficiently granting access to a resource may be possible by reducing the “depth” or rigor of such a determination, such an approach may carry a higher risk as compared to a more traditional process. The present disclosure addresses this trade-off by automatically obtaining information and identifying a set of rules for assessing risks associated with the requestor accessing the resources, such that information for reviewing a request for the resource may be automatically retrieved and verified. For example, information associated with the requestor may be obtained from one or more data providers and/or reviewers and used for completing the review.

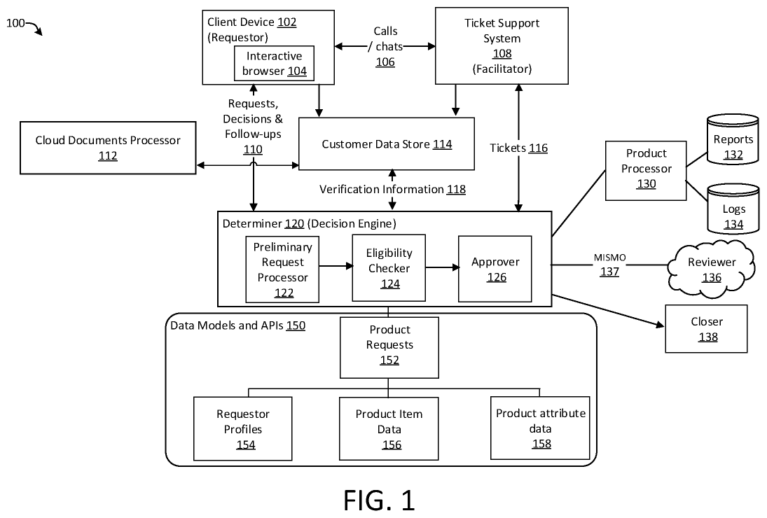

FIG. 1 illustrates an overview of an example system of processing a request for a resource in accordance to aspects of the present disclosure. System 100 may represent a system for processing the request for a resource or a product that enables the requestor access the resource.

The system 100 includes a client device 102, a ticket support system 108, a cloud documents processor 112, a customer data store 114, a determiner 120 (a decision engine), a product processor 130, a reviewer 136, a closer 138, and data models and application programming interfaces (APIs) 150. In aspects, the determiner 120 receives an indication of a request from client device 102 for a resource or an item (e.g., a product) that enables the requestor to access the resource (e.g., as may be generated as a result of a user/requestor interacting with client device 102). Accordingly, determiner 102 may collect information (e.g., credentials of the requestor, intended use of the requested resource, and the like) used for determining whether to grant access to the resource. In examples, determiner 120 may interact with a reviewer 136 (e.g., underwriters) to receive results of one or more analyses associated with the requestor and/or resource. Accordingly, determiner 120 may determine whether to grant access to the resource based at least in part on the information and/or analyses.

The client device 102 interacts with a user and/or a requestor of a resource and/or a product that enables the requestor to access the resource). The client device 102 includes an interactive browser 104, which renders content as the user creates and places a request for a product. A requestor of a product may place a request for the product by providing information used to obtain the product, which may be submitted by the client device 102 accordingly. The client device 102 may interact with the determiner 120 (a decision engine) and may communicate information received from the requestor and/or may request additional information from the requestor as indicated by determiner 120. For example, a prospective borrower of a loan product may submit identification information and a selection of a desired product using the interactive browser 104 of the client device 102.

The ticket support system 108 tracks tickets associated with matters, as may be generated (e.g., by determiner 120) as a result of a request by a requestor for a product. For example, a device used by a coordinator (e.g., a sales agent and/or a support agent) communicates with the client device 102 being used by the requestor via phone calls and text chats 106. The requestor of a product may interact with the coordinator (e.g., an agent that coordinates access to one or more products) about accessing the resource and the product. The ticket support system 108 may send and receive tickets 116 with the determiner 120. The determiner 120 may include information associated with determining whether to grant the requestor use of the product or access to the resource. For example, the requestor may receive a notification when an evaluation by determiner 120 is paused. In such an instance, additional information may be obtained from the requestor (e.g., by a coordinator), which may be provided by determiner 120 accordingly.

The customer data store 114 stores customer data associated with customers who place requests for products and access to resources. In particular, the customer data store 114 may store data (e.g., identification information) from the client device 102. As an example, the customer data store 114 may interact with the client device 102 and/or the cloud documents processor 112 (API) to receive information associated with the requestor from cloud services.

The determiner 120, as a decision engine, receives a request for a product from a requestor using the client device 102. Accordingly, the determiner 120 may verify data associated with the requestor. For example, determiner 120 may check eligibility of the requestor and may receive results of reviewers to determine whether to approve the request for a product. In aspects, the determiner 120 includes a preliminary request processor 122, an eligibility checker 124, and an approver 126.

The preliminary request processor 122 receives a request (i.e., a preliminary request) for a product, which includes basic information about the requestor and/or conditions of the product being requested. In aspects, the request may be without specifying a product but includes conditions. For example, the basic information about the requestor may include identification information (e.g., driver license information of the requestor). The conditions may include information associated with a real estate property, an amount, a number of months, and/or a type of rates (e.g., fixed or varied) of a mortgage / loan product being requested. The preliminary request processor 122 stores the request in a data model (e.g., the data models and APIs 150). For example, a request for access to a resource and/or an application associated with a product may be generated based on the basic information. The preliminary request processor 122 then retrieves verified data associated with the requestor and/or data associated with the product from a plurality of data providers. In aspects, the preliminary request processor 122 may automatically obtain the verified information from the various data providers over the network. The preliminary request processor 122 may validate consistency of the received data and may create or update a request for access to a resource and/or an application for a product by setting values into fields of the application.

The preliminary request processor 122 may process the application by comparing the requestor information against the guidelines and/or rules (e.g., as may be associated with a product). In some examples, the preliminary request processor 122 may generate a list of one or more products that may be available to the requestor. For example, the list of one or more products may include one or more mortgage and loan products for which the prospective borrower satisfies respective eligibilities. Thus, a product list according to aspects described herein may differ according to the requestor for which such processing is performed. The determiner 120 transmits the list of products to the client device 102. In some examples, the determiner 120 provides an indication of additional information that would be used to process a product request (i.e., a subsequent request, and/or a formal request), such that the additional information may be obtained from the requestor by client device 102 and/or accessed from any of a variety of sources (e.g., cloud documents processor 112 and/or reviewer 136). Accordingly, the client device 102 may receive a selection of a product from the list by a requestor, such that a request for the product may be submitted along with additional information for the selected product.

The eligibility checker 124 checks whether the requestor of the product is eligible to obtain, use, or otherwise access a specific product. In aspects, the eligibility checker 124 uses a set of eligibility rules as defined in product definitions. The product definitions may include, but are not limited to, an amount of resources that the product enables access to, a set of conditions imposed by the product upon the requestor for the product to enable the requestor access the resource. For example, product definitions for a mortgage product may include a mortgage amount, a number of months to repay, and a set of conditions upon a property (e.g., a resource). The eligibility rules may include a minimum age of the requestor, a range of income, and a range of a monetary value associated with the resource, and the like. In aspects, the eligibility checker 124 determines that a requestor is eligible when information associated with the requestor passes one or more rules while not satisfying any disallow rules. For example, the approver 126 may approve a requestor when information associated with the requestor satisfies the eligibility rules and/or guidelines.

In aspects, the approver 126 determines a status of the request for a product in one of four types: approved, paused with tasks, rejected, and out of scope. The “approved” status represents a state where the request for the product is approved. The “paused with tasks” status represents a state where the determiner 120 needs additional information associated with the requestor making a decision. The “rejected” status represents a state where the request for the product is rejected because of the analysis of the requestor according to aspects described herein (e.g., based on processing information from client device 102, cloud documents processor, and/or reviewer 136) according to rules and/or guidelines) indicates that the requestor is disqualified. The “out of scope” status represents an instance where the requestor fails to meet conditions set by qualification statements associated with the requested product. While example statuses are provided, it will be appreciated that fewer, additional, or alternative statuses may be used in other examples.

The approver 126 approves the request for a product based on results of the above-described processing. The approver 126 of the determiner 120 instructs the closer 138 to close the request and informs the client device 102 about the approved status. In aspects, a preliminary request may include information that is reduced as compared to a subsequent request, but is still sufficient for the determiner 120 to start identifying and generating a list of products for selection by the requestor. For example, the preliminary request may include information associated with an identity of the requestor and a description of a resource (e.g., an amount of memory resource, an amount of monetary resource, attributes of a property, and the like) that the requestor intends to request. The subsequent request may include a request for a product that the requester has selected from the list of products. The subsequent request may include an identifier of the requestor, an identifier of the product and one or more information needed by the determiner 120 and by the reviewer 136 for assessing whether to grant an access to the resource by providing the product.

The product processor 130 processes products based on decisions made by the determiner 120 for providing the product to the requestor. For example, the product processor 130 communicates with resource providers for granting the requestor an access to the resource as may be specified by the product. For instance, a mortgage product processor may transfer monetary resources to the requestor. The product processor 130 may also manage inventory of the products being offered to requestors. The product processor 130 connects with various databases and reporting processors, including, but not limited to, reports database 132 and logs 134.

The reviewer 136, responsive to receiving a request from the determiner 120, reviews a request for a product. For example, the reviewer 136 may receive information associated with the requestor and the products from the determiner 120 over the network. The reviewer may obtain the set of rules from the determiner 120 and/or from a local storage or other servers. In aspects, the reviewer validates whether conditions of the requestor satisfy the rules for granting access to the resource by providing the product. For example, the reviewer 136 may interactively provide conditions and rules associated with the requestor and the product for completing the review process and receive instructions from one or more underwriters that perform underwriting on applications for mortgage products. In aspects, the underwriters may be a plurality of distinct underwriters distributed across a network. The disclosed technology may automatically connect with the respective underwriters over the network using data exchange protocols (e.g., the Mortgage Industry Standards Maintenance Organization (MISMO) for exchanging information and conducting business in the mortgage finance industry.)

The closer 138 closes a request for a product and/or provides access to a resource. For example, the closer 138 processes closing of mortgage and loan products based on approved applications. In aspects, the determiner 120 (the decision engine) instructs the closer 138 to perform the closing process. The closer 138 transmits a result of the closing to the determiner 120. Accordingly, the determiner 120 provides the decision and the closed status to the client device 102. In aspects, closing the request may include granting access to the requested resource. In some other aspects, the closing may represent a completion of the decision-making process to approve access to the requested resource.

The data models and APIs 150 include subsequent requests 152, requestor profiles 154, product item data 156, and product attribute data 158. The determiner 120 uses the respective data in the data models and APIs 150 to collect information associated with the requestor and the product. In particular, the determiner 120 retrieves verification information 118 associated with the requestor from the customer data store 114 and updates the data models. In aspects, the verification information 118 may include data associated with verifying an identity and/or credentials of the requestor. For example, the requestor profiles 154, the product item data 156, and/or the product attribute data 158 may be updated. Additionally or alternately, the determiner 120 receives product information from the product processor 130 and updates data models including the product attribute data 158.

For example, the subsequent requests 152 may include requests for any of a variety of resources, including, but not limited to, computing resources, physical goods or services, or for mortgage or loan products. For example, a request for a mortgage or loan may include a type, a purpose, an amount, and costs & fees associated with the loan product for which the prospective borrower has applied. The requestor profiles 154 may comprise information associated with a requestor. Returning to the above example, customer information therein may include financial profiles associated with the requestor that is applying for a loan product. The requestor profiles 154 may include income, asset, credit of the requestor, and the like. The product item data 156 may include any of a variety of information associated with a product that is requested by a requestor. For instance, product item data 156 may include, in the example of processing mortgage or loan applications, information associated with real estate properties for which the mortgage or loan products may be applicable. The product item data may include a profile, an appraisal, and a title information associated with the real estate properties over time. In aspects, a tile / appraisal service provider (not shown in FIG. 1) may provide information that is stored as part of the product item data 156. The product attribute data 158 may comprise data associated with subsequent request processing according to aspects described herein. For example, the product attribute data 158 may include rules and guidelines associated with assessing qualifications of the prospective borrowers of the financial products. The product item data 156 may further include information associated with price adjustments based on various conditions set by the rules, underwriting rules, and a rate sheet for pricing.

As should be appreciated, the various methods, devices, applications, features, etc., described with respect to FIG. 1 are not intended to limit the system 100 to being performed by the particular applications and features described. Accordingly, additional controller configurations may be used to practice the methods and systems herein and/or features and applications described may be excluded without departing from the methods and systems disclosed herein.

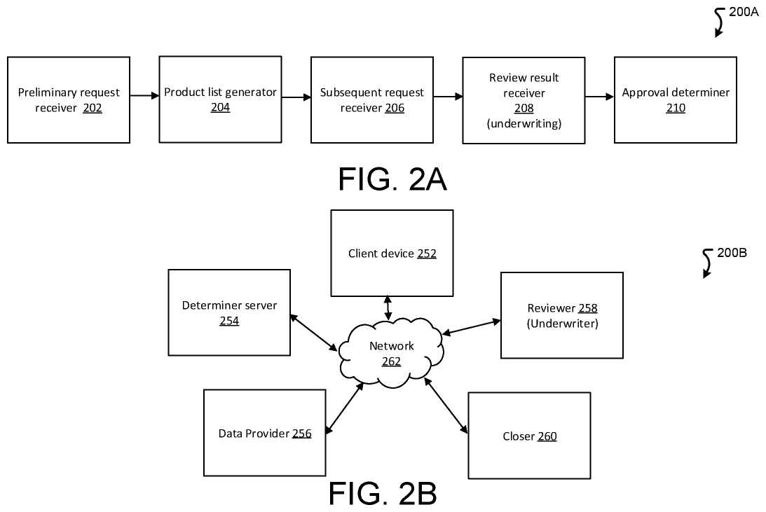

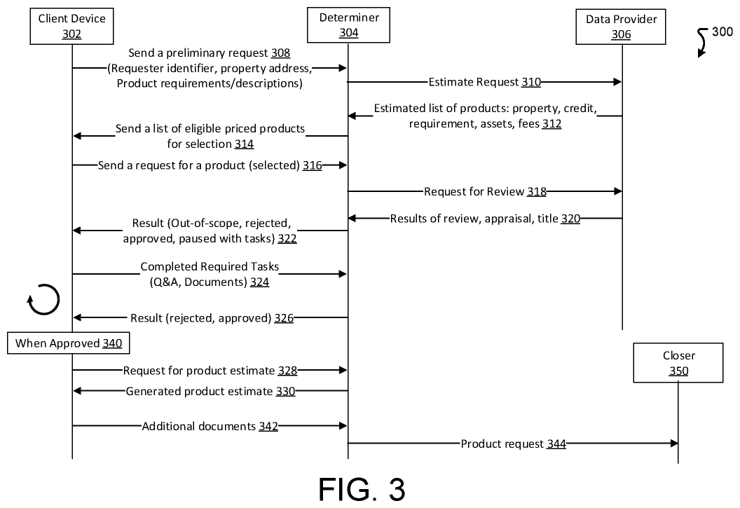

FIG. 2A illustrates an example system for processing a request for a product in accordance with aspects of the present disclosure. The system 200A receives a preliminary request followed by a request for a product and determines whether to approve the request by coordinating with reviewers (e.g., underwriters). The system includes a preliminary request receiver 202, a product list generator 204, a subsequent request receiver 206, a review result receiver 208, and an approval determiner 210. In some aspects, the system 200A may receive a final or “subsequent” request without previously receiving the preliminary request. Such aspects may thus eliminate the process of providing the list of products and making a selection of a product from the list. Rather, the request may specify a particular product as a requested product.

The preliminary request receiver 202 receives a preliminary request for a product. The preliminary request may include basic information associated with a requestor and a high-level description of a product that the requestor requests without specifying the actual product. For example, the basic information of the requestor may include driver's license data or other identification information for the request (e.g., as may be obtained by the client device by scanning the requester's driver's license). The driver's license data may include, for example, a name, an address, and a birthdate of the requestor. The high level description of the product may include, for example, an address or region of a real estate property for which the requester seeks a mortgage product, an amount to be borrowed, and a term (e.g., a number of years) of the mortgage, and a type of applying interests (e.g., a fixed rate and a variable rates).

The preliminary request receiver 202 may request and subsequently receive verified information associated with the requestor from one or more data providers over the network. For example, the verified information may include a social security number, credit history, criminal history, a current monthly income, and an amount of debt by the requestor. The verified information may be obtained based at least in part on the basic information that was received from the requestor. For example, the request for a product may include an application for a mortgage product by a borrower. Processing the mortgage application may include pre-approval and/or underwriting based on information associated with the borrower. An issue may arise when processing the request for a product is time-consuming and is not optimized for prospective borrowers with varying risk levels. Accordingly, aspects described herein may be applied in such instances so as to reduce the processing time associated with a request such as a mortgage application, such that information may be obtained in advance or contemporaneously with other aspects of the evaluation, thereby yielding an approval of the request in a shorter amount of time and/or with reduced resource consumption that would otherwise be possible when using other techniques, among other benefits.

The product list generator 204 generates a list of one or more products for which the requestor is eligible based on the given basic information. The product list generator 204 further determines a set of tasks and documents needed from the requestor to determine whether provide respective products to the requestor. For example, the set of tasks and documents may include a copy of a pay slip to show a recent income. The product list generator 204 transmits the list of eligible products to the client device (e.g., the client device 102). In some instances, the list of eligible products may comprise an indication of products for which the requestor is eligible absent additional information and/or processing, in addition to products for which the requestor may be eligible as a result of providing additional information and/or after additional processing according to aspects described herein.

The subsequent request receiver 206 receives a subsequent request from the client device for a product that specifies a particular product. The subsequent request receiver 206 may solicit from the requestor the set of tasks and documents. For example, the subsequent request may include information about a prospective borrower of a mortgage, real estate property information, and a specific mortgage product that the prospective borrower is interested. In other examples, the selected product may not require additional information and/or processing, as may be the case when the basic information is sufficient to grant the requestor access to the requested product.

The subsequent request receiver 206 may request reviewers (e.g., the reviewer 136 or underwriters) for a decision on the specified product. In aspects, the subsequent request receiver 206 may determine a result of the request is “out of scope” when the determiner (e.g., the determiner 120) is not able to make a decision. Respective reviewers and/or underwriters evaluate the request based on underwriting rules.

The review result receiver 208 receives results of reviews/underwriting. In aspects, a decision may include an indication that it has been rejected (the requestor or the borrower is disqualified), paused (there are tasks, unanswered questions and/or document needed to receive verified document needs), and approved (or a conditional approval). The review result receiver 208 may provide an opportunity to the requestor to submit answers to the unanswered questions and/or the document needed.

The approval determiner 210 determines whether to approve the request for the specific product, for example based on information received from the requestor, information associated with the property, and/or an indication received from the reviewer. Once determined to approve, the approver determiner 210 may request the closer (e.g., the closer 138 in FIG. 1) to close the request. In aspects, closing may include a completion of granting an access to the requested resource. In some other aspects, closing may represent a completion of the decision-making process to approve an access to the requested resource.

FIG. 2B is an example of systems for processing a request for a product in accordance with aspects of the present disclosure. The system 200B includes a client device 252 (e.g., the client device 102 as shown in FIG. 1), a determiner server 254, a data provider 256, a reviewer 258, and a closer 260. A network 262 interconnects the aforementioned devices and servers. In aspects, the system 200B indicates a distributed environment where a requester of a product may submit the request for a product from a remote location. The determiner server 254 (e.g., the determiner 120 as shown in FIG. 1) may receive information associated with the requestor and other information used for determining whether to approve the request from the data provider 256 (e.g., the cloud documents processor 112 as shown in FIG. 1) over the network 262. In aspects, the reviewer 258 (e.g., the reviewer 136 as shown in FIG. 1 and/or an underwriter) and the closer 260 (e.g., the closer 138 as shown in FIG. 1) may be at distributed locations connected via the network 262. In some other aspects, a set of the determiner server 254, the reviewer 258, and the closer 260 may be co-located. The network 262 may include network segments that are either one of or both of fixed line or wireless.

As should be appreciated, the various methods, devices, applications, features, etc., described with respect to FIGS. 2A-B are not intended to limit the systems 200A-B to being performed by the particular applications and features described. Accordingly, additional controller configurations may be used to practice the methods and systems herein and/or features and applications described may be excluded without departing from the methods and systems disclosed herein.

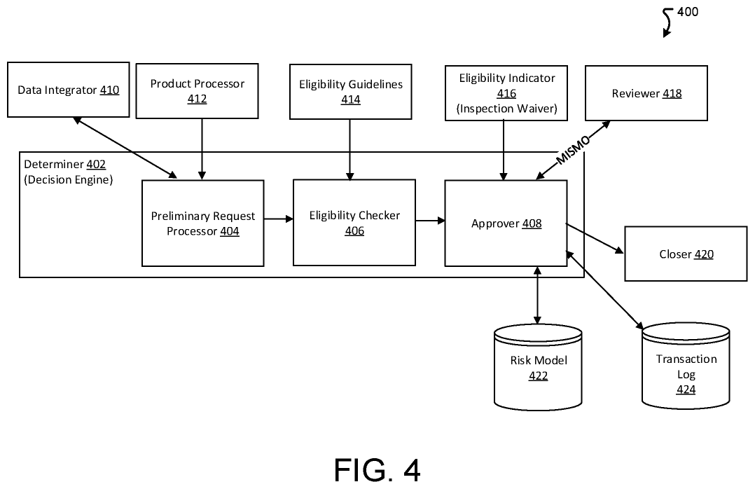

FIG. 3 is a timing chart of communications among a client device 302, a determiner 304, a data provider 306, and a closer 350. Generally, the timing chart 300 starts with a send operation 308 and ends with a product request 344. The timing chart 300 may include more or fewer steps or may arrange the order of the steps differently than those shown in FIG. 3. The timing chart 300 can be executed as a set of computer-executable instructions executed by a computer system and encoded or stored on a computer readable medium. Further, processing according to the timing chart 300 can be performed by gates or circuits associated with a processor, an ASIC, an FPGA, a SOC or other hardware device. Hereinafter, the timing chart 300 shall be explained with reference to the systems, component, devices, modules, software, data structures, data characteristic representations, signaling diagrams, methods, etc. described in conjunction with FIGS. 1, 2, 4, 5A-C, 6A-C, 7, 8A-D, and 9.

The client device 302 sends (308) a preliminary request for a product. The preliminary request identifies a requester and includes descriptions about some product requested. In aspects, the preliminary request does not specify a particular product. For example, identification of the requester may include on a scanned image of a driver's license of the requestor. The descriptions about the product may include an address and other information associated with a real estate property to apply the product if approved. The descriptions may further include a number of years and a type of interests of a mortgage/loan product (e.g., a 15-year fixed rate mortgage for $200,000). Thus, it will be appreciated that the preliminary request may comprise a product description that describes a set of products, even though it may not specifically identify one or more products within the set.

The determiner 304 receives the preliminary request and sends (310) an estimate request for estimating the eligible products. The data provider 306 processes the received preliminary request and sends (312) a list of eligible products for which the requestor may be potentially eligible in response. The list of eligible products provides identifiers, descriptions, and information needed to assess whether to grant access to the eligible products. The determiner 304 sends (314) a list of eligible priced products for user selection. In aspects, the list may include a name, terms, and an interest rate of a mortgage product that the requestor is eligible to apply.

The client device 302 receives the list of eligible products and displays the list for interactive selection. In aspects, the requestor may select a product using a graphical user interface (GUI). The client device 302 sends (316) a request for the selected product. In aspects, the client device 302 may interactively receive additional information about the requestor beyond the basic information, which may be sent in association with the selected product to the determiner 304.

The determiner 304 receives the request for the selected product and instructs (318) the data provider 306 to execute a review of the request for determining whether to approve the request. In aspects, the determiner 304 communicates with reviewers to assess and decide on the requested product. The determiner 304 receives (320) a result of the review along with and appraisal and a title of the real estate property. In examples, the determiner 304 may process additional information that is received from client device 302 in addition to or as an alternative to requesting (318) review of the request for approval.

The determiner 304 accordingly provides (322) a result of assessing the request for the product. For example, the result may be one or more of: out-of-scope, rejected, approved, and paused-with-tasks. In aspects, the determiner 304 provides out-of-scope when the determiner 304 determines that the request is not reviewable. The rejected status may occur when the review process results in a rejection. The approved status may occur when the review process results in an approval. The paused-with-tasks may occur when the reviewers need additional information from the requestor to finalize a decision. It will be appreciated that these results are provided as examples, and, in other examples, additional, alternative, or fewer results may be provided. Further, in some examples, additional information may be provided in association with the result, such as an explanation as to why the requestor is receiving the generated result or other information that may yield a different result if the requestor were to resubmit the request.

The client device 302 displays the received result. When the result indicates “paused-with-tasks,” the client device 302 may solicit for the additional or missing information to facilitate the review process. The requestor may use the client device 302 to input the additional or missing information. The client device 302 may upload (324) completed required tasks (e.g., answers to questions and additional documents). In aspects, the process of informing (346) a result and requesting for additional information and uploading the additional information may take place iteratively or repeatedly until information is complete and the determiner approves or rejects the request.

When the request is approved (340), the client device 302 may send (328) a request for product estimate. The determiner 304 may generate a product estimate (e.g., a loan estimate) and sends (330) the generated product estimate with additional information needed to close the review process. The client device 302 uploads (342) the additional information. The determiner 304 accordingly instructs the closer 350 to close the request process. For example, the closer 350 may close the application for the mortgage and/or loan product for which the determiner has approved.

In some other aspects, the determiner 304 may determine and automatically fulfill the request for the product and/or an access to resources after approving the request (e.g., without receiving additional information). For example, the determiner 304 may proceed to close the request without requesting for the additional information to the client device 302.

As should be appreciated, operations 308-344 are described for purposes of illustrating timing of the present method and systems and are not intended to limit the disclosure to a particular sequence of steps, e.g., steps may be performed in different order, an additional steps may be performed, and disclosed steps may be excluded without departing from the present disclosure.

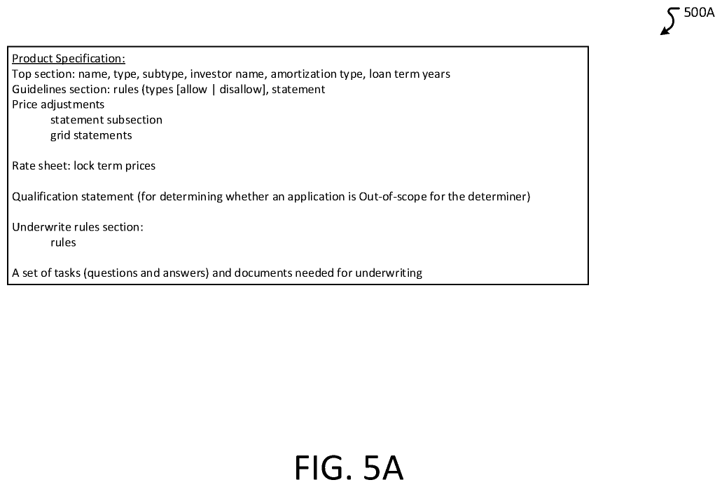

FIG. 4 illustrates an example system of a decision engine (e.g., the determiner 120 (a decision engine) as illustrated in FIG. 1). Determiner 402 (a decision engine) includes a preliminary request processor 404, an eligibility checker 406, and an approver 408. The preliminary request processor 404 automatically retrieves verified information associated with the requestor and items and/or products (e.g., real estate property data in case of a request for a mortgage product, as may enable a requestor to acquire the real estate property) from data providers over the network through a data integrator 410. The preliminary request processor 404 retrieves a list of eligible products based on the verified information from the product processor 412 (e.g., the product processor 130 as shown in FIG. 1).

In aspects, there may be a plurality of distinct product processors. The product processor 412 processes products based on decisions made by the determiner 402 for providing the product to the requestor. For example, the product processor 412 communicates with one or more resource providers for granting the requestor access to the resource, as may be specified by the product. For instance, a mortgage product processor may transfer monetary resources to the requestor. The product processor 412 may also manage inventory of the products being offered to requestors.

The eligibility checker 406 retrieves guidelines and/or rules associated with a requested product from the eligibility guidelines data 414. In aspects, the guidelines and/or rules may include decision criteria for determining whether to provide the requested product. The guidelines and rules may further include a list of information and documents needed to make a decision on approval.

The approver 408 may approve (or reject) the request for the product as a result of review process described herein, for example by processing associated information and/or interacting with a reviewer 418. In aspects, the requestor may forgo one or more processes that may otherwise be used to assess and determine whether to grant the product (and/or grant an access to the resources). For example, during the approval process, the approver 408 may receive an indication of an inspection waiver (e.g., a property inspection waiver (PIW), in case of a mortgage application) with an eligibility indicator 416 (inspection waiver). The reviewer 418 may include a plurality of distinct underwriters distributed over a network to make a decision. In aspects, data transmission between the approver 408 and the reviewer 418 over the network may use a protocol, such as an API or the MISMO protocol for automatic interactions with the reviewer 418 over the network, for example while underwriting the mortgage / loan application.

The approver 408 interacts with a closer 420 after approving the request for the product and receives information indicative of the closing of the request. For example, the closer 420 grants, delivers, or otherwise facilitates access to a requested product once the request has been approved. Returning to the above example, closer 420 closes the approved mortgage/loan application. In aspects, the approver 408 records transactions of closer 420 in a transaction log 424. For example, the transaction log 424 may include information associated with requests for a product and results associated with respective requests. In aspects, the approver 408 may use a risk model 422 to determine a level of risk associated with providing a specified product to the requestor. The risk model 422 may provide the requester as a high risk when the model infers that information associated with the requestor would likely result in a loss associated with the product.

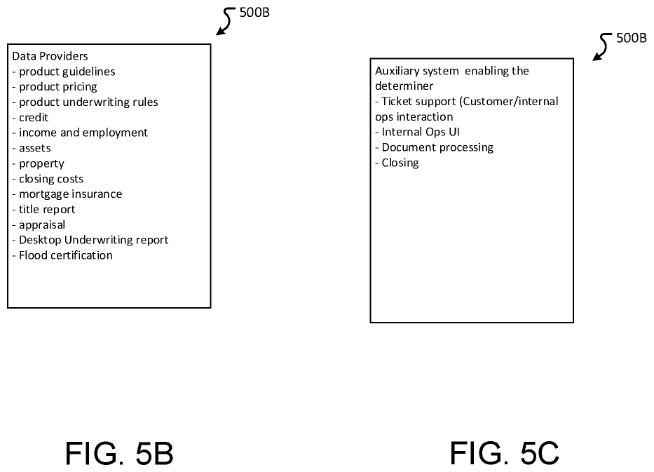

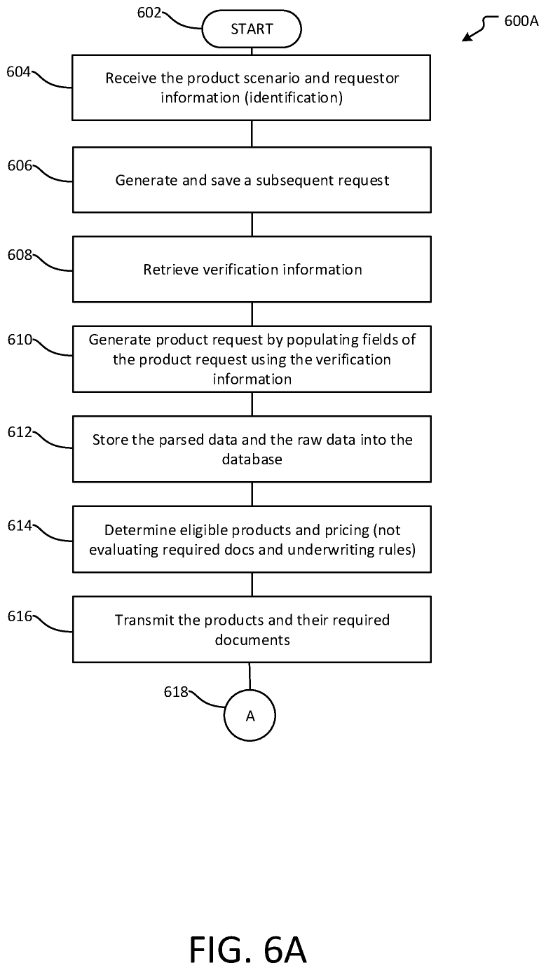

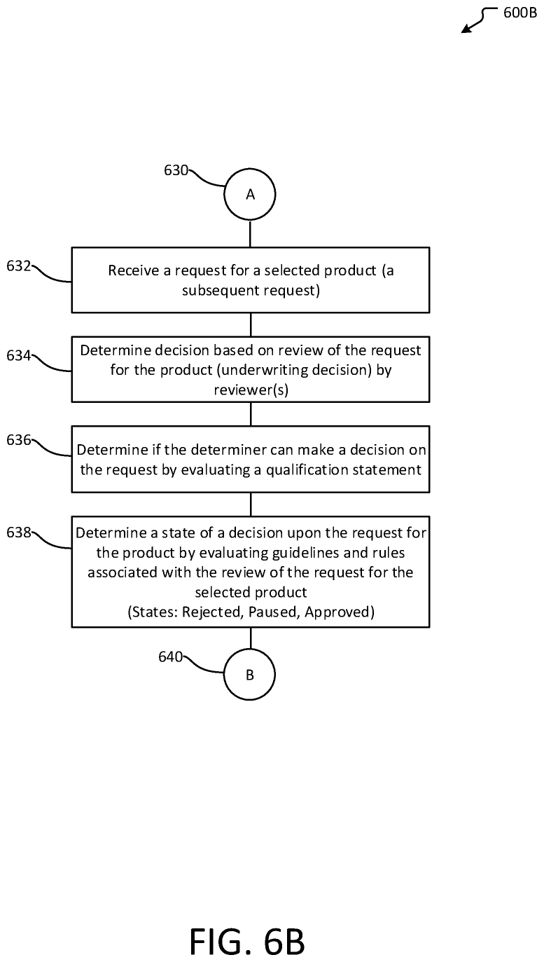

FIGS. 5A-C illustrate examples of data associated with processing a request for a product in accordance with aspects of the present disclosure. FIG. 5A illustrates an example data structure 500A of a product specification in the context of a mortgage/loan product. In the top section of the data structure, the product specification may include a name, a type, a subtype, an investor name, an amortization type, and loan term years in a top section. In the guidelines section, the data includes rules that indicate whether to allow or disallow the product and rule statements associated respective rules.

A price adjustment section of the data structure 500A includes conditions for whether the determiner adjusts the product base price. Grid statements indicate one or more rules to specify the actual amount of the adjustment on the product pricing. A rate sheet describes rates used to lock term prices based on terms (e.g., a number of years and interest types) to lock term prices. A qualification statement includes one or more statements used to determine if a request for the product is out-of-scope for the determiner.

An underwriting rules section includes a set of rules for underwriting a request (e.g., a mortgage application) once a product is selected. In aspects, the data structure 500A may include distinct underwriting rules for a distinct risk profile associated with a requestor. The data structure 500A may further include a list of one or more questions and documents needed to underwrite or otherwise approve the request.

The example as detailed above does not limit a scope of the present disclosure. Other product specifications may be used in other contexts. For example, virtual computing servers may define a set of conditions for using various resources for virtual computing (e.g., a size of virtual memory, an amount of processing capabilities, and the like) as product specifications. The requestor (e.g., a requesting client of the cloud computing) may specify the product (e.g., virtual CPU cores and the like) and the determiner may assess and determine whether to grant access to the resources.

FIG. 5B illustrates an example data structure 500B associated with a data provider in accordance with aspects of the present disclosure. In particular, the data structure 500B is based on an example of processing an application for a mortgage or loan product. The data provider data may include, but not limited to: product guidelines, product pricing, product underwriting rules, credit, income and employment, assets, property, closing costs, mortgage insurance, title report, appraisal, underwriting report, and flood certification. In the context of the example of processing a mortgage or loan product, the product guidelines may be used for evaluating a request for the product (e.g., the eligibility of a loan application by a requestor). The product underwriting rules specifies documents and/or information needed for approval, as well as rules that may be used to verify the documents and/or information. The validated information associated with the requestor of a product may be used to evaluate debts, payment history, public records, credit score, identity verification, and the like. The income and employment data may be used to evaluate income and employment history of the requestor for determining eligibility to respective mortgage or loan products. The assets data may be used to enable evaluation of a requestor's total assets, for example for determining closing cost payment and required reserves. The real estate property data may be used to determine initial quotes of a mortgage product. The closing costs (e.g., third party service fees, title/closing fees, taxes, prepaids, and initial escrow payment) are needed for closing disclosures of a product request (e.g., a mortgage application). The mortgage insurance costs adds costs to a final quote of a mortgage product. The title report may be needed in final closing costs and closing disclosure. The appraisal data may be used to determine a property value when PIW is not available. The underwriting report may be needed for verification of providing a mortgage or loan product. Some property needs the flood certification.

The example as detailed above does not limit a scope of the present disclosure. Other data providers may include, for example in a virtual server computing scenario, data associated with the current status of resource consumption in a virtual server (e.g., an amount of free memory, an amount of processing resources available, and the like).

The data providers (e.g., the cloud documents processor 112 and the product processor 130 as shown in FIG. 1 and the data provider 306 as shown in FIG. 3) automatically provide verification information associated with the requestor and products through communications over the network.

FIG. 5C illustrates an example data structure 500C associated with auxiliary systems in accordance with aspects of the present disclosure. The auxiliary systems enable the determiner (e.g., the determiner 120 (the decision engine) in FIG. 1, the determiner 304 in FIG. 3, and the determiner 402 as shown in FIG. 4) to automatically and accurately determine whether to approve a request for a product. The processors may include a ticket support system (e.g., the ticket support system 108 as shown in FIG. 1), a user interface for internal operations and maintenance, a document processing system, and a closing system.

The ticket support system processes action items during paused underwriting execution and conditional approval, users may need support from a facilitator or a technical support. The user interface for internal operations and maintenance displays requests for products (e.g., mortgage/loan applications) and may be used by a user to manually complete actions as needed. The documents processing system performs the uploading process of information and documents needed for review. The closing system (e.g., the closer 138 as shown in FIG. 1) generates closing documents, warehousing of products (e.g., loans), and product packages (e.g., the loan packages) to deliver to the requestors (e.g., the investors and/or the borrowers).

The example as detailed above does not limit a scope of the present disclosure. Other examples of auxiliary system supporting the determiner may include controllers of physical memory and processing resources in a virtual computer, a scheduler of processes, and allocators of physical and/or virtual memory and processing resources.

As should be appreciated, data structures 500A-C are described for purposes of illustrating the present methods and systems and are not intended to limit the disclosure to using specific data structures in a particular sequence of steps, e.g., steps may be performed in different order, an additional steps may be performed, and disclosed steps may be excluded without departing from the present disclosure.

In aspects, the disclosed technology may provide following exception handling in reviewing and approving requests for products. Returning to the example of processing a mortgage or loan application, if initial verification data is unavailable, a request may be reviewed for pre-approval rather than for full approval. If it is decided a request is out-of-scope as a result of processing the request according to aspects described herein, the request may similarly be reviewed for pre-approval rather than for full approval. If after selecting product and there are problems with completing tasks, an alert may be generated and manual interactions with the requestor may be facilitated to resolve one or more issues with completing tasks (e.g., answering questions and uploading document needed). Example interactions include via electronic messaging, voice messaging, and/or video messaging. If appraisal or title indicates ineligibility for the selected product, the determiner may restructure the requested product into an eligible product or may provide an indication as to a different product in which the requestor may be interested. If a verification of employment shows the requestor is no longer employed, the determiner may request updated employment and/or income information or, as another example, the determiner may reject the request. Such aspects are provided as example exception handling techniques via which additional information may be requested and/or processing may be performed as part of processing a request according to aspects described herein.

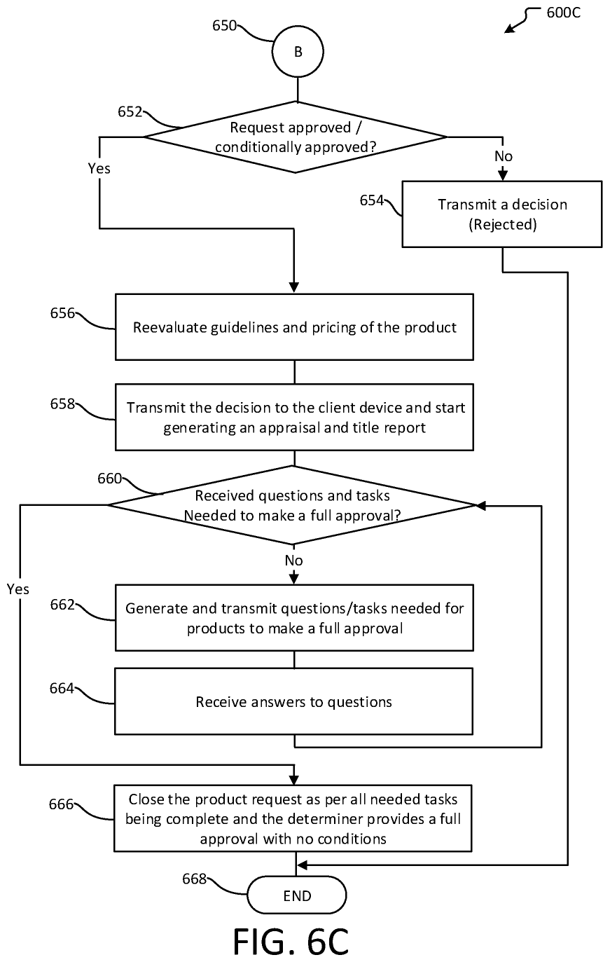

FIGS. 6A-C illustrate examples of a method of processing a request for a product in accordance with aspects of the present disclosure. A general sequence of operations of the method 600A is shown in FIG. 6A. Generally, the method 600A starts with a start operation 602 and ends with a step 618 labeled as “A.” The method 600A may include more or fewer steps or may arrange the order of the steps differently than those shown in FIG. 6A. The method 600A can be executed as a set of computer-executable instructions executed by a computer system and encoded or stored on a computer readable medium. Further, the method 600A can be performed by gates or circuits associated with a processor, an ASIC, an FPGA, a SOC or other hardware device. Hereinafter, the method 600A shall be explained with reference to the systems, component, devices, modules, software, data structures, data characteristic representations, signaling diagrams, methods, etc. described in conjunction with FIGS. 1, 2, 3, 4, 5A-C, 6B-C, 7, 8A-D, and 9.

Following the start operation 602, a receive operation 604 receives a product scenario and requestor information. In aspects, the product scenario includes product definitions, which describes conditions and rules associated with the product. For example, the product scenario may include an amount of resources to be accessed, a time duration, and/or a frequency and an associated amount of resource installations (e.g., payment terms and monthly mortgage amounts). In some aspects, a determiner (e.g., the determiner 120 as shown in FIG. 1) receives the product scenario and requestor information as a preliminary request for a product. The product scenario may include descriptions and/or conditions associated with a product for which the requestor is looking. The product scenario need not specify a particular product. For example, in a case of applying for a mortgage or loan product, the product scenario includes an amount for borrowing, a number of years of payment, and a type of interests (e.g., fixed or variable rates). The requestor information may include but not limited to identification information (e.g., as may be obtained from the driver's license of the requestor). In aspects, the receive operation 604 receives a scanned image of a driver's license of the requestor. The receive operation 604 may perform character recognition to extract the requester's information including a name, an address, a birth date and other information from the scanned image. For example, the request for a product may include an application for a mortgage product by a borrower. Processing the mortgage application may include pre-approval and/or underwriting based on information associated with the borrower. An issue arises when processing the request for a product is time-consuming and not optimized for prospective borrowers with varying risk levels. In other examples, character recognition may be performed by the client device or any of a variety of other techniques may be used to obtain identification information associated with a requestor.

A generate operation 606 generates a subsequent product request (e.g., which may be saved in a database) based on the preliminary request for a product that was received at operation 604. In some examples, the generated product request may be incomplete or may be termed a preliminary product request as used herein, because the received information associated with the product request may be limited to identification information associated with the requestor.

A retrieve operation 608 retrieves verification information associated with the requestor from one or more data providers. For example, the retrieve operation 608 may automatically retrieve a social security number and a credit history of the requestor from one or more data providers over the network, among other information.

A generate operation 610 generates a subsequent request for a product. In aspects, the generate operation 610 parses the retrieved verification information from the data providers and populates fields of the product request being generated as the subsequent request. In some aspects, the generate operation 610 further determines verified information associated with the requestor. For example, the higher-level data points may include the current income and real estate properties associated with the requestor. The retrieve operation 608 may insert the retrieved raw data to the product request for review. In some other aspects, the generate operation 610 generates a subsequent request for resources in virtual computing by populating placeholders for specifying the need for the resources (e.g., amounts of memory and processing resources and a priority level) based on the resource needs of the requesting client application.

A store operation 612 stores the verification information into the database (e.g., the customer data store 114 according to data models and APIs 150 as shown in FIG. 1). While example retrieval and storage techniques are described, it will be appreciated that any of a variety of other techniques may be used to obtain and/or store information associated with a requestor and/or requested product or, in other examples, such information need not be stored.

A determine operation 614 retrieves from a product processor one or more eligible products and pricing of the respective products based on the information associated with the requestor and the product scenario and determines the eligible products for generating a list of eligible products. In aspects, the retrieve operation retrieves a list of products for which the requestor is eligible to formally request or apply. For example, in case of applying for a mortgage or loan product, the list of products includes a list of mortgage or loan products, each product matching with information associated with the requestor and the product scenario. In some aspects, the retrieve operation 614 retrieves product data without the product processor or the determiner evaluating verification information and documents needed to approve respective products. This way, the determine operation 614 saves time for generating a list of eligible products without finalizing approvals on each of the eligible products at this step.

A transmit operation 616 transmits the list of products to the client device. In some instances, the list is transmitted in association with information and/or documents that would be used for additional processing of a product request (e.g., as may result from selection of a product from the list). In aspects, the client device may display the list of products and additional information and/or documents that would be used to formally request for a specific product. Accordingly, the requestor (i.e., a user of the client device) may select a product from the list. The client device may request the requestor the additional information and/or documents as needed before submitting the selection for request. A step “A” indicates a subsequent set of operations starts at the step “A” as shown in FIG. 6B.

As should be appreciated, operations 602-618 are described for purposes of illustrating the present methods and systems and are not intended to limit the disclosure to a particular sequence of steps, e.g., steps may be performed in different order, additional steps may be performed, and disclosed steps may be excluded without departing from the present disclosure.

FIG. 6B illustrates an example sequence of operations for processing a request for a product in accordance with aspects of the present disclosure. A general sequence of operations of the method 600B is shown in FIG. 6B. Generally, the method 600B starts with a step 630 labeled as “A” and ends with a step 640 labeled as “B.” The method 600B may include more or fewer steps or may arrange the order of the steps differently than those shown in FIG. 6B. The method 600B can be executed as a set of computer-executable instructions executed by a computer system and encoded or stored on a computer readable medium. Further, the method 600B can be performed by gates or circuits associated with a processor, an ASIC, an FPGA, a SOC or other hardware device. Hereinafter, the method 600B shall be explained with reference to the systems, component, devices, modules, software, data structures, data characteristic representations, signaling diagrams, methods, etc. described in conjunction with FIGS. 1, 2, 3, 4, 5A-C, 6A, 6C, 7, 8A-D, and 9.

Following the step 630 labeled as “A,” a receive operation 632 receives a selected product from the client device. In aspects, the receive operation 632 may receive information and/or documents needed for reviewing the request (as a subsequent request) for the selected product in addition to the basic information associated with the requestor.

A determine operation 634 determines a decision on the received request for the selected product. In aspects, the decision corresponds to an underwriting decision on an application for a mortgage or loan product. In aspects, the determine operation 634 may include dispatching a request to one or more reviewers (e.g., the reviewer 136 as shown in FIG. 1), such that each reviewer may determine whether to approve the request for the product. Accordingly the respective results of the reviewers may be received over the network.

A determine operation 636 determines if the determiner can make a decision on the request for the selected product, whether the determination should not be made, or whether additional information should be obtained prior to making the decision. In examples, the determine operation 636 determines the qualification by evaluating a qualification statement. For example, the determiner may make decisions on mortgage applications for houses but not for condominiums. The qualification statement may defines a scope of reviews that the determiner may make. The evaluate operation 636 may evaluate the selected product against information of a real estate property and may determine that the determiner cannot review a request for a mortgage or loan product associated with condominiums.

A determine operation 638 determines a status of a decision of reviewing the request for the product. In aspects, the determine operation 638 determines the state by evaluating guidelines and rules associated with reviewing the request for the selected product. The determine operation 638 may evaluate the additional information and documents received from the client device for underwriting. In aspects, there may be three types of a result: rejected, paused, and approved. The rejected state indicating that the requestor (e.g., the borrower of the mortgage or loan product) is disqualified. The paused state indicates that there are tasks for retrieving verified information, unanswered questions and/or documents needed to make a full decision. The approved state indicates that the requestor has a conditional approval of the product. In aspects, the conditional approval needs further information and documents from the requestor after the requestor reviewing final conditions of the product (e.g., loan estimate of the mortgage or loan product being approved) to make a full approval with no condition. The step 640 labeled as “B” indicates that a subsequent set of operations appear in FIG. 6C.

As should be appreciated, operations 630-640 are described for purposes of illustrating the present methods and systems and are not intended to limit the disclosure to a particular sequence of steps, e.g., steps may be performed in different order, additional steps may be performed, and disclosed steps may be excluded without departing from the present disclosure.

FIG. 6C illustrates an example sequence of operations associated with processing a request for a product in accordance with aspects of the present disclosure. A general sequence of operations of the method 600C is shown in FIG. 6C. Generally, the method 600C starts with a step 650 labeled as “B” and ends with an end operation 668. The method 600C may include more or fewer steps or may arrange the order of the steps differently than those shown in FIG. 6C. The method 600C can be executed as a set of computer-executable instructions executed by a computer system and encoded or stored on a computer readable medium. Further, the method 600C can be performed by gates or circuits associated with a processor, an ASIC, an FPGA, a SOC or other hardware device. Hereinafter, the method 600C shall be explained with reference to the systems, component, devices, modules, software, data structures, data characteristic representations, signaling diagrams, methods, etc. described in conjunction with FIGS. 1, 2, 3, 4, 5A-C, 6A-B, 7, 8A-D, and 9.

Following the step 650 labeled as “B,” a decision operation 652 decides whether the request for the selected product has been approved (i.e., conditionally approved). In some aspects, when the request is approved, the sequence of operations proceeds to a reevaluate operation 656. In other aspects, the method 600C may proceed to the close operation 666 when the decision operation 652 decides the request as being approved. The reevaluate operation 656 reevaluates guidelines and pricing of the approved product. In aspects, reevaluation operation 656 may be omitted in instances where a product has locked terms and conditions.

A transmit operation 658 transmits the decision with a status to the client device. In some examples, the transmit operation 658 may also request information and/or documents that may be used for determining a full approval without condition. Subsequent to the transmit operation 658, the sequence of operations may receive such information and/or documents. In aspects, the transmit operation 658 further initiates a process for appraisal and generating a title report in the example of applying for a mortgage or loan product.

A decision operation 660 decides whether the received information and/or documents that have been obtained for the product request are sufficient to complete full approval. When the information and/or documents are not sufficient, the sequence of operation proceeds to a generate operation 662. The generate operation 662 generates and transmits one or more questions for information, requests for documents, and/or tasks that may be used to make a full approval of the request. For example, in the case of processing an application for a mortgage or loan product, the questions may include a remaining balance of a savings account under the requester's name and a contact information of a co-guarantor of the requestor.

A receive operation 664 receives answers to questions and/or documents needed for making a full approval of the product. The sequence operations then proceeds to the decision operation 660 again to decide whether information and documents needed for making a full approve has been received.

When the decision operation 660 decides that sufficient information and/or documents for making a full approval of the product have been received, the sequence of operations proceeds to a close operation 666. The close operation 666 closes the product request (e.g., a loan application) and the determiner provides a full approval with no conditions. In aspects, closing may include granting access to the requested resource. In some other aspects, closing may represent completion of the decision-making process to approve access to the requested resource.

Returning to decision operation 652, if it is instead determined that the request is not approved, the operation proceeds to a transmit operation 654. The transmit operation 654 transmits the rejection decision to the client device and the sequence ends at operation 668.

In aspects, sales of financial products including mortgages and loans may include collecting a variety of information associated with identity and creditworthiness of a requestor (e.g., a prospective borrower). Its approval process may include collecting information associated with the requestor, underwriting, and deciding whether to provide the product through underwriting. In case of approving a mortgage product, the review may need information associated with a real estate property for examining appraisals and a title. Traditionally, the sequence of processes have been too complex and time consuming for the requestor to simply request for the financial products from smartphones and to expect completion of the review instantly. Simplifying the process by, for example, skipping some of underwriting and providing the products may be convenient for the requestors using the mobile computing device. However, comprising steps of reviewing information associated with the prospective borrower may excessively increase a level of risks for providers of the products.

For example, a review process of the request for the financial products may include pre-approvals, conditional approvals based on results of underwriting by providers of the financial products. The underwriting process may include assessing risks of providing the product by reviewing background information of the user (i.e., the requestor, the applicant, and the like).

Based on the determined credit risk, the disclosed technology in some aspects makes a credit decision in real time and closes the mortgage application process without pre-approval. The disclosed technology further simplifies a process of registering new mortgage products by providing UI for receiving condition data associated with applicant eligibility, types of data for automated data retrieval, and conditions associated with making a credit decisions.

As should be appreciated, operations 650-668 are described for purposes of illustrating the present methods and systems and are not intended to limit the disclosure to a particular sequence of steps, e.g., steps may be performed in different order, additional steps may be performed, and disclosed steps may be excluded without departing from the present disclosure.

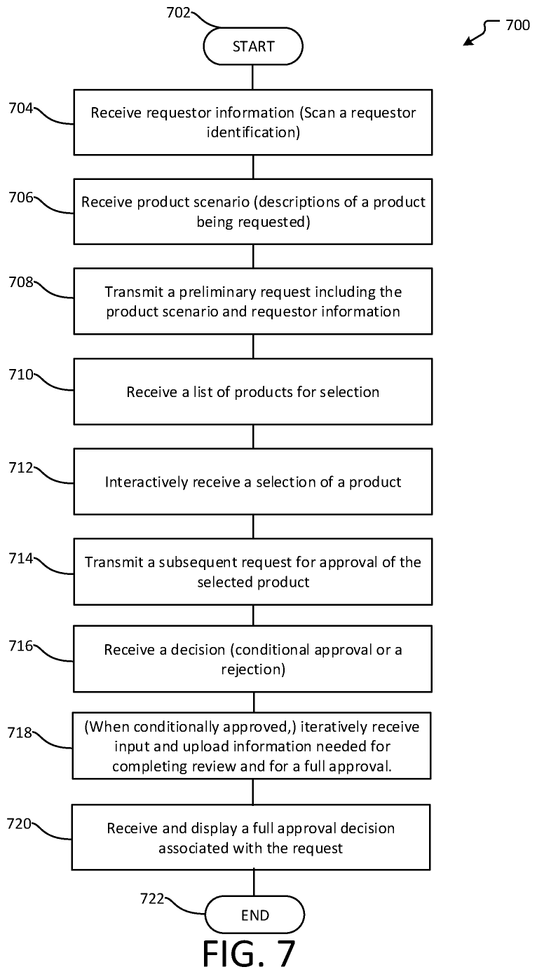

FIG. 7 illustrates an example of a method of processing a request for a product in accordance with aspects of the present disclosure. In particular, the method in FIG. 7 is associated with processing by the client device used by a requestor of the product. A general sequence of operations of the method 700 is shown in FIG. 7. Generally, the method 700 starts with a start operation 702 and ends with an end operation 722. The method 700 may include more or fewer steps or may arrange the order of the steps differently than those shown in FIG. 7. The method 700 can be executed as a set of computer-executable instructions executed by a computer system and encoded or stored on a computer readable medium. Further, the method 7 can be performed by gates or circuits associated with a processor, an ASIC, an FPGA, a SOC or other hardware device. Hereinafter, the method 700 shall be explained with reference to the systems, component, devices, modules, software, data structures, data characteristic representations, signaling diagrams, methods, etc. described in conjunction with FIGS. 1, 2, 3, 4, 5A-C, 6A-C, 8A-D, and 9.

Following the start operation 702, a receive operation 704 receives requestor information. In aspects, the client device scans or a take a photo of a driver's license and/or other document that identifies the requestor.

A receive operation 706 receives a product scenario. In aspects, the product scenario may include descriptions of a product that the requestor intends to request but without specifying a particular product, as discussed above. For example, in an instance where a requestor is applying for a mortgage or loan product, the product scenario may include a number of years, a type of interests, an amount, and information about a real estate property (e.g., 15-year, fixed rate product in the amount of $300,000, for a real estate property (a single family house) located at an address).

A transmit operation 708 transmits the product scenario and the requestor information to the determiner (i.e., the determiner 120 as shown in FIG. 1). In aspects, the product scenario includes product definitions, which describes conditions and rules associated with the product. For example, the product scenario may include an amount of resources to be accessed and a time duration and an amount of monetary installations (e.g., payment terms and monthly mortgage amounts). The requestor information may include an identification of the requestor, such as identification information and/or an image of a driver's license, and the like.

A receive operation 710 receives a list of eligible products for selection. In some aspects, the list may include only one eligible product. The receive operation 710 may also receive an indication of additional information and/or documents that would be used (e.g., by a determiner, such as determiner 130 in FIG. 1) to process a request for respective products. The client device may display the received list of eligible products. The user selects one product from the list. Additionally or alternatively, the client device may display there is no eligible product and may solicit the requestor to modify the descriptions of the product needed.

A receive operation 712 receives a selection of a product from the list of eligible products. The client device may further prompt the requestor for additional information and/or documents as needed.

A transmit operation 714 transmits a subsequent request for approval on the selected product. In aspects, the client device may transmit additional information and/or documents provided or otherwise identified by the requestor, which may be used to process the request according to aspects described herein.

A receive operation 714 receives a decision of the review. A type of the decision may include but not limited to “rejected,” “approval (conditional approval),” “pause for more information,” and “out of scope.” In aspects, the sequence operations may end when the receive operation 714 receives one of “rejected” or “out of scope.” It will be appreciated that such decisions are provided as examples and, in other examples, any of a variety of additional, alternative, or fewer decisions may be received.

When conditionally approved, a receive operation 718 may iteratively receive additional input from the requestor, which may be uploaded for additional review of the product request, such that a full approval of the product request may ultimately be achieved.

Eventually, a receive operation 720 receives and displays a full approval decision associated with the request. For example, the receive operation 720 receives and displays a message that a mortgage or loan application has been fully approved and, in some examples, closed according to the product scenario. In aspects, the receive operation 720 receives additional information associated with the fully approved product. For example, the receive operation 720 may receive a loan estimate for the approved loan product. By the requester confirming the estimate, the client device may transmit the confirmation and the determiner communicates with the closer to close the loan application. Thus, a product request may be approved and subsequently closed automatically or as a result of an indication provided by the requestor, among other examples.

As should be appreciated, operations 702-720 are described for purposes of illustrating the present methods and systems and are not intended to limit the disclosure to a particular sequence of steps, e.g., steps may be performed in different order, additional steps may be performed, and disclosed steps may be excluded without departing from the present disclosure.

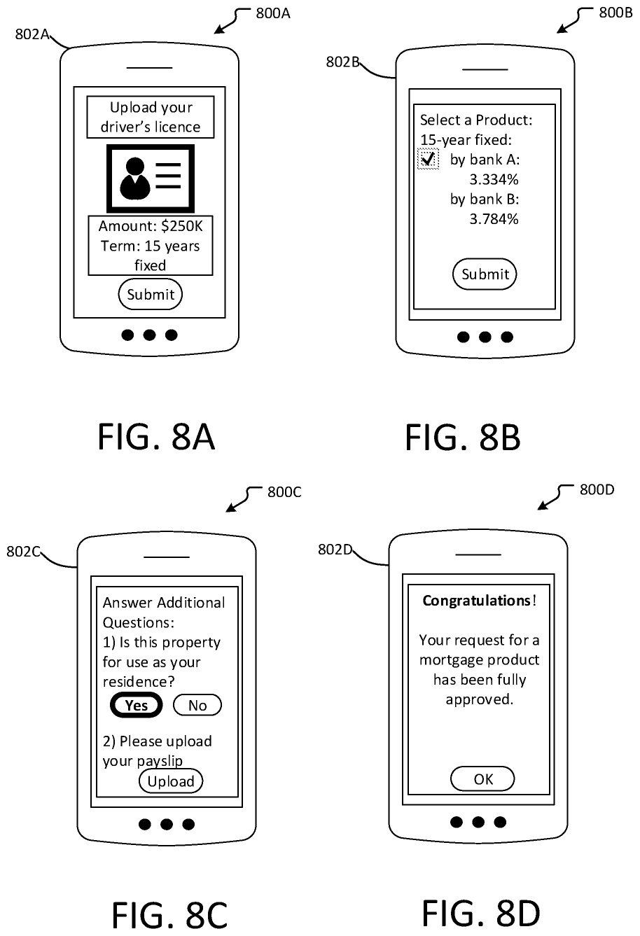

FIGS. 8A-D illustrate examples of graphical user interface (GUI) as rendered on a mobile computing device in accordance with aspects of the present disclosure. FIG. 8A illustrates an example screen display of a client device. In particular, the example 800A shows a smartphone 802A that displays an instruction to upload a scanned image of a driver's license of the requestor with loan amount of $250,000. While not shown, the GUI may ask the requestor to enter an address information of a real estate property to apply the mortgage, among other product information. The client device may proceed to prompt the requestor to enter a product scenario, which may be provided in association with the scanned image of the driver's license to the determiner over the network. Selecting the submit button may cause the smartphone 802A to transmit a preliminary request that requests a list of eligible products.

FIG. 8B illustrates an example screen display of the client device. In particular, the example 800B illustrates a screen of a smartphone 802B, displaying a list of eligible products and request the requester to select one of the products from the list. In aspects, the determiner generates a list of the eligible products based on a previously received preliminary request received from the client device. For example, the display shows two products that are eligible: one mortgage product by bank A at an interest rate of 3.334% and another mortgage product by bank B at an interest rate of 3.784%. The check button indicates a selection being made by the requestor. In aspects, the requestor using the client device may review the list of eligible products based on the limited information about the requestor and a high-level description of a requested product (e.g., an amount of mortgage). The requestor may select an eligible product from the list and submit as a subsequent request for the selected product. Selecting the submit button may transmit information associated with the selected product to the determiner.

FIG. 8C illustrates an example screen display of the client device. In particular, the example 800C illustrates a screen display of a smartphone 802C soliciting additional information as a question form and a document for the determiner to make a decision. For example, the question states: “is this property for use as your residence?” The answer from the requestor may be yes or no. Furthermore, the screen solicits the requester to scan and upload an image of a pay slip as evidence of recent income by the requestor.

FIG. 8D illustrates an example screen display of the client device. In particular, the example 800D illustrates a screen display of a smartphone 802D showing a final result of a request for a product. For example, the smartphone 802D receives a status of the subsequent request for the product as approved by the determiner (e.g., the determiner 120 as shown in FIG. 1, as may occur as a result of the transmit operation 658 and/or the close operation 666 as shown in FIG. 6C). For example, the display indicates that the request for a mortgage product has been fully approved (e.g., a mortgage application has been fully approved and closed).

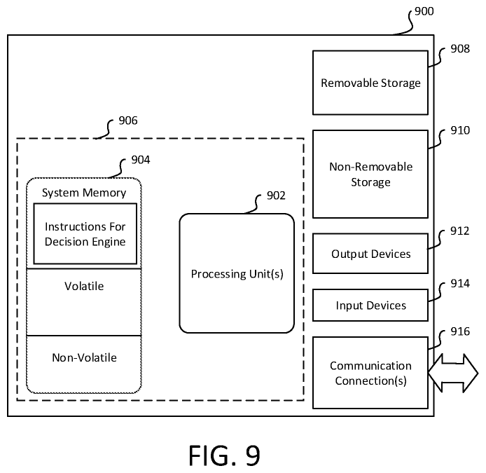

FIG. 9 illustrates a simplified block diagram of a device with which aspects of the present disclosure may be practiced in accordance with aspects of the present disclosure. The device may be a mobile computing device, for example. One or more of the present embodiments may be implemented in an operating environment 900. This is only one example of a suitable operating environment and is not intended to suggest any limitation as to the scope of use or functionality. Other well-known computing systems, environments, and/or configurations that may be suitable for use include, but are not limited to, personal computers, server computers, hand-held or laptop devices, multiprocessor systems, microprocessor-based systems, programmable consumer electronics such as smartphones, network PCs, minicomputers, mainframe computers, distributed computing environments that include any of the above systems or devices, and the like.

In its most basic configuration, the operating environment 900 typically includes at least one processing unit 902 and memory 904. Depending on the exact configuration and type of computing device, memory 904 (instructions to perform a cellular-communication-assisted PPV as described herein) may be volatile (such as RAM), non-volatile (such as ROM, flash memory, etc.), or some combination of the two. This most basic configuration is illustrated in FIG. 9 by dashed line 906. Further, the operating environment 900 may also include storage devices (removable, 908, and/or non-removable, 910) including, but not limited to, magnetic or optical disks or tape Similarly, the operating environment 900 may also have input device(s) 914 such as remote controller, keyboard, mouse, pen, voice input, on-board sensors, etc. and/or output device(s) 912 such as a display, speakers, printer, motors, etc. Also included in the environment may be one or more communication connections, 916, such as LAN, WAN, a near-field communications network, a cellular broadband network, point to point, etc.

Operating environment 900 typically includes at least some form of computer readable media. Computer readable media can be any available media that can be accessed by the at least one processing unit 902 or other devices comprising the operating environment. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other tangible, non-transitory medium which can be used to store the desired information. Computer storage media does not include communication media. Computer storage media does not include a carrier wave or other propagated or modulated data signal.

Communication media embodies computer readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

The operating environment 900 may be a single computer operating in a networked environment using logical connections to one or more remote computers. The remote computer may be a personal computer, a server, a router, a network PC, a peer device or other common network node, and typically includes many or all of the elements described above as well as others not so mentioned. The logical connections may include any method supported by available communications media. Such networking environments are commonplace in offices, enterprise-wide computer networks, intranets and the Internet.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, for example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

The present disclosure relates to systems and methods for processing a request for a product according to at least the examples provided in the sections below. The method comprises receiving, by a server, a first product request from a client device, wherein the client device is associated with a requestor; automatically obtaining, based on the first product request, information associated with the requestor from one or more data providers over a network; generating, based on the obtained information associated with the requestor and one or more eligibility rules associated with products, a list of eligible products for the requestor; receiving a second product request, wherein the second product request includes information associated with a product selected from the list of eligible products; obtaining, over the network, one or more results of a review of a request from the requestor for the product; automatically determining, based on the obtained one or more results, an approval for the product; and transmitting an indication of the automatically determined approval to the client device. The first product request includes identification information of the requestor, and a product scenario, wherein the product scenario includes a description of at least one product being requested without specifying a particular product. The information associated with the requestor includes verification information for authenticity obtained from the one or more data providers over the network. The review includes determining whether one or more conditions associated with the request satisfy a set of predetermined rules. The approval for the product is further determined based on the obtained information associated with the requestor from the one or more data providers. The method further comprises retrieving, based on the product scenario, one or more products; retrieving one or more eligibility rules associated with the one or more products; selecting, based on the one or more eligibility rules, one or more eligible products from the one or more products; generating the list of eligible products, wherein the list of eligible products includes the determined one or more eligible products; and transmitting the list of eligible products to the client device. The method further comprises automatically transmitting, based on the second product request, a combination of the information associated with the requestor and information associated with the product to one or reviewers over the network for evaluating the requestor.

Another aspect of the technology relates to a system for processing a request for a product. The system comprises a processor; and a memory storing computer-executable instructions that when executed by the processor cause the system to receive, by a server, a first product request from a client device, wherein the client device is associated with a requestor; automatically obtain, based on the first product request, information associated with the requestor from one or more data providers over a network; generate, based on the obtained information associated with the requestor and one or more eligibility rules associated with products, a list of eligible products for the requestor; receive a second product request, wherein the second product request includes information associated with a product selected from the list of eligible products; obtain, over the network, one or more results of a review of a request from the requestor for the product; automatically determine, based on the obtained one or more results, an approval for the product; and transmit an indication of the automatically determined approval to the client device. The first product request includes identification information of the requestor, and a product scenario, wherein the product scenario includes a description of at least one product being requested without specifying a particular product. The information associated with the requestor includes verification information for authenticity obtained from the one or more data providers over the network. The review includes determining whether one or more conditions associated with the request satisfy a set of predetermined rules. The approval for the product is further determined based on the obtained information associated with the requestor from the one or more data providers. The computer-executable instructions when executed further cause the system to retrieve, based on the product scenario, one or more products; retrieve one or more eligibility rules associated with the one or more products; select, based on the one or more eligibility rules, one or more eligible products from the one or more products; generate the list of eligible products, wherein the list of eligible products includes the determined one or more eligible products; and transmit the list of eligible products to the client device. The computer-executable instructions when executed further cause the system to automatically transmit, based on the second product request, a combination of the information associated with the requestor and information associated with the product to one or reviewers over the network for evaluating the requestor.

In still further aspects, the technology relates to a computer-implemented method for processing a request for a product. The method comprises receiving, by a client computing device, requestor information associated with a requestor for the product; receiving one or more attributes associated with a potential product to be requested; transmitting, to a determiner server, a preliminary request that includes the requestor information and the one or more attributes associated with the product; receiving by the client computing device, a list of products from the determiner server; receiving, from the requestor, a selection of a product from the list of products; transmitting, to the determiner server, a subsequent request that includes the selection of the product; receiving, from the determiner server, a decision associated with the subsequent request for the product, wherein the decision includes a full approval decision associated with the product; and displaying, by the client computing device, an indication of the decision. The selected product enables the requestor to access a resource matching the one or more attributes associated with the products. The transmitting the subsequent request causes the determiner server to obtain, over a network, verification information associated with the requestor and the product, and to determine whether to approve the subsequent request. The method further comprises receiving, by the client computing device, additional information associated with the request for the product from the determiner server; displaying a request for additional information associated with the requestor; receiving, from the requestor, the additional information; and transmitting, to the determiner server, the additional information. The decision includes one of a full approval, a conditional approval, or a rejection. The transmitting the subsequent request causes the determiner server to transmit a request for reviewing the request for the product to at least one reviewer server over the network.

Any of the one or more above aspects in combination with any other of the one or more aspect. Any of the one or more aspects as described herein.

What is claimed is:

1. A computer-implemented method of processing a request for a product, the method comprising:
receiving, by a server, a first product request from a client device, wherein the client device is associated with a requestor;
automatically obtaining, based on the first product request, information associated with the requestor from one or more data providers over a network;
generating, based on the obtained information associated with the requestor and one or more eligibility rules associated with products, a list of eligible products for the requestor;
receiving a second product request, wherein the second product request includes information associated with a product selected from the list of eligible products;
obtaining, over the network, one or more results of a review of a request from the requestor for the product;
automatically determining, based on the obtained one or more results, an approval for the product; and
transmitting an indication of the automatically determined approval to the client device.

2. The computer-implemented method of claim 1, wherein the first product request includes:
identification information of the requestor, and
a product scenario, wherein the product scenario includes a description of at least one product being requested without specifying a particular product.

3. The computer-implemented method of claim 1, wherein the information associated with the requestor includes verification information for authenticity obtained from the one or more data providers over the network.

4. The computer-implemented method of claim 1, wherein the review includes determining whether one or more conditions associated with the request satisfy a set of predetermined rules.

5. The computer-implemented method of claim 1, wherein the approval for the product is further determined based on the obtained information associated with the requestor from the one or more data providers.

6. The computer-implemented method of claim 1, the method further comprising:
retrieving, based on the product scenario, one or more products;
retrieving one or more eligibility rules associated with the one or more products;
selecting, based on the one or more eligibility rules, one or more eligible products from the one or more products;
generating the list of eligible products, wherein the list of eligible products includes the determined one or more eligible products; and
transmitting the list of eligible products to the client device.

7. The computer-implemented method of claim 1, the method further comprising:
automatically transmitting, based on the second product request, a combination of the information associated with the requestor and information associated with the product to one or reviewers over the network for evaluating the requestor.

8. A system for processing a request for a product, the system comprises:
a processor; and
a memory storing computer-executable instructions that when executed by the processor cause the system to:
receive, by a server, a first product request from a client device, wherein the client device is associated with a requestor;
automatically obtain, based on the first product request, information associated with the requestor from one or more data providers over a network;
generate, based on the obtained information associated with the requestor and one or more eligibility rules associated with products, a list of eligible products for the requestor;
receive a second product request, wherein the second product request includes information associated with a product selected from the list of eligible products;
obtain, over the network, one or more results of a review of a request from the requestor for the product;
automatically determine, based on the obtained one or more results, an approval for the product; and
transmit an indication of the automatically determined approval to the client device.

9. The system of claim 8, wherein the first product request includes:
identification information of the requestor, and
a product scenario, wherein the product scenario includes a description of at least one product being requested without specifying a particular product.

10. The system of claim 8, wherein the information associated with the requestor includes verification information for authenticity obtained from the one or more data providers over the network.

11. The system of claim 8, wherein the review includes determining whether one or more conditions associated with the request satisfy a set of predetermined rules.

12. The system of claim 8, wherein the approval for the product is further determined based on the obtained information associated with the requestor from the one or more data providers.

13. The system of claim 8, the computer-executable instructions when executed further causing the system to:
retrieve, based on the product scenario, one or more products;
retrieve one or more eligibility rules associated with the one or more products;
select, based on the one or more eligibility rules, one or more eligible products from the one or more products;
generate the list of eligible products, wherein the list of eligible products includes the determined one or more eligible products; and
transmit the list of eligible products to the client device.

14. The system of claim 8, the computer-executable instructions when executed further causing the system to:
automatically transmit, based on the second product request, a combination of the information associated with the requestor and information associated with the product to one or reviewers over the network for evaluating the requestor.

15. A computer-implemented method for processing a request for a product, the method comprising:
receiving, by a client computing device, requestor information associated with a requestor for the product;
receiving one or more attributes associated with a potential product to be requested;
transmitting, to a determiner server, a preliminary request that includes the requestor information and the one or more attributes associated with the product;
receiving by the client computing device, a list of products from the determiner server;
receiving, from the requestor, a selection of a product from the list of products;
transmitting, to the determiner server, a subsequent request that includes the selection of the product;
receiving, from the determiner server, a decision associated with the subsequent request for the product, wherein the decision includes a full approval decision associated with the product; and
displaying, by the client computing device, an indication of the decision.

16. The computer-implemented method of claim 15, wherein the selected product enables the requestor to access a resource matching the one or more attributes associated with the products.

17. The computer-implemented method of claim 15, wherein the transmitting the subsequent request causes the determiner server to obtain, over a network, verification information associated with the requestor and the product, and to determine whether to approve the subsequent request.

18. The computer-implemented method of claim 15, the method further comprising:
receiving, by the client computing device, additional information associated with the request for the product from the determiner server;
displaying a request for additional information associated with the requestor;
receiving, from the requestor, the additional information; and
transmitting, to the determiner server, the additional information.

19. The computer-implemented method of claim 15, wherein the decision includes one of: a full approval, a conditional approval, or a rejection.

20. The computer-implemented method of claim 15, wherein the transmitting the subsequent request causes the determiner server to transmit a request for reviewing the request for the product to at least one reviewer server over a network.
